(19) United States
(12) Patent Application Publication
(10) Pub. No.: US 2021/0314116 A1
(43) Pub. Date: Oct. 7, 2021

(54) A METHOD, DEVICE AND COMPUTER READABLE MEDIA FOR UPLINK RESOURCE MAPPING

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 17/261,925

(22) PCT Filed: Aug. 6, 2018
(86) PCT No.: PCT/CN2018/099047

§ 371 Date: Jan. 21, 2021

(51) Int. Cl. H04L 5/00; H04W 72/04

(52) U.S. Cl. CPC H04L 5/0048; H04W 72/0413; H04W 72/0466

(57) ABSTRACT

Embodiments of the present disclosure relate to a method, device and computer readable medium for uplink resource mapping. In an embodiment of the present disclosure, a method for uplink resource mapping is performed at a terminal device. In the method, a reference signal sequence, generated based on a predetermined sequence group, is scrambled by a scrambling sequence to obtain another reference signal sequence complementary with the reference signal sequence, and the reference signal sequence and the another reference signal sequence are mapped respectively onto a plurality of clusters within an interlace, by spreading the reference signal sequence with a first spreading sequence and spreading the another reference signal sequence with a second spreading sequence complementary with the first spreading sequence, wherein the reference signal sequence and the another reference signal sequence are respectively mapped onto a first part and a second part of the plurality of clusters within the interlace.

### FIELD OF THE INVENTION

The non-limiting and exemplary embodiments of the present disclosure generally relate to the field of wireless communication techniques, and more particularly relate to a method, device and computer readable medium for uplink resource mapping in a wireless communication system.

### BACKGROUND OF THE INVENTION

This section introduces aspects that may facilitate better understanding of the disclosure. Accordingly, the statements of this section are to be read in this light and are not to be understood as admissions about what is in the prior art or what is not in the prior art.

New radio access system, which is also called as NR system or NR network, is the next generation communication system. In Radio Access Network (RAN) #71 meeting for the third generation Partnership Project (3GPP) working group, study of the NR system was approved. The NR system will consider frequency ranging up to 100 Ghz with an object of a single technical framework addressing all usage scenarios, requirements and deployment scenarios defined in Technical Report TR 38.913, which includes requirements such as enhanced mobile broadband, massive machine-type communications, and ultra-reliable and low latency communications.

In order to improve the data rate performance, in 3GPP Long Term Evolution (LTE), there was introduced License Assisted Access (LAA) for both downlink and uplink transmission.

In some regions, channel occupancy requirement on signal transmission is specified on unlicensed bands. For example, in European Telecommunications Standards Institute (ETSI) regulation, it specifies that the signal occupied bandwidth shall be at least 80% (5 GHz) of the declared nominal channel bandwidth. In Long Term Evolution (LTE) system, for Downlink (DL) transmission in unlicensed bands, this requirement could be easily fulfilled since the network device could provide services to multiple users in Frequency Division Multiplexing (FDM) manner at the same time, and the same waveform for NR DL licensed carriers could be reused on the unlicensed bands. While for the UL data transmission on the unlicensed band, an interlace-based UL resource mapping scheme is utilized on LAA Physical Uplink Shared Channel (PUSCH) to support FDM based multiplexing between User Equipment (UE) on the same subframe. Thus, each UE may use a maximum transmission power while satisfying this regulatory requirement for channel occupancy.

As the LTE network enters its next phase of evolution with the study of wider bandwidth waveform under the NR project, solutions on the NR unlicensed band (NR-U) are studied.

### SUMMARY OF THE INVENTION

In general, example embodiments of the present disclosure provide new solutions for uplink resource mapping in a wireless communication system.

According to a first aspect of the present disclosure, there is provided a method for uplink resource mapping at a terminal device in a wireless communication system. The method may include scrambling a reference signal sequence generated based on a predetermined sequence group by a scrambling sequence to obtain another reference signal sequence complementary with the reference signal sequence, and mapping the reference signal sequence and the another reference signal sequence onto a plurality of clusters within an interlace, by spreading the reference signal sequence with a first spreading sequence and spreading the another reference signal sequence with a second spreading sequence complementary with the first spreading sequence, wherein the reference signal sequence and the another reference signal sequence are respectively mapped onto a first part and a second part of the plurality of clusters within the interlace.

According to a second aspect of the present disclosure, there is provided a terminal device. The terminal device may comprise at least one processor and at least one memory coupled with the at least one processor. The at least one memory has computer program codes stored therein which are configured to, when executed on the at least one processor, cause the terminal device to perform operations of the first aspect.

According to a third aspect of the present disclosure, there is provided a computer-readable storage medium having a computer program stored thereon which, when executed by at least one processor of a device, causes the device to perform actions in the method according to any embodiment in the first aspect.

According to a fourth aspect of the present disclosure, there is provided a computer program product comprising a computer-readable storage medium according to the third aspect.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 illustrates an example interlace for the UL PUSCH transmission on the unlicensed band in the prior art.

FIG. 2 illustrates Physical Uplink Control Channel (PUCCH) formats in the NR system;

FIG. 3 schematically illustrates results of cubic metric (CM) simulation of data transmission and reference signal transmission in a straightforward repetition interlacing solution;

FIG. 4 schematically illustrates a flow chart of a method for uplink resource mapping at a terminal device in a wireless communication system according to some embodiments of the present disclosure;

FIG. 5 schematically illustrates a block diagram of a system for uplink resource mapping in a wireless communication system according to some embodiments of the present disclosure;

FIG. 6 schematically illustrates a block diagram of another system for uplink resource mapping in a wireless communication system according to some embodiments of the present disclosure;

FIG. 7 schematically illustrates a block diagram of a further system for uplink resource mapping in a wireless communication system according to some embodiments of the present disclosure;

FIG. 8 schematically illustrates results of CM simulation on different resource mapping options according to some embodiments of the present disclosure;

FIGS. 9A and 9B schematically illustrate results of correlation simulation on different resource mapping options according to some embodiments of the present disclosure;

FIG. 10 schematically illustrates results of another CM simulation on resource mapping options according to some embodiments of the present disclosure;

FIGS. 11A to 11C schematically illustrate spreading sequence determination schemes according to some embodiments of the present disclosure;

FIG. 12 schematically illustrates results of CM simulation on different spreading sequence determination schemes according to some embodiments of the present disclosure;

FIG. 13 schematically illustrates results of CM simulation on RB block spreading and bit rate matching according to some embodiments of the present disclosure;

FIG. 14 schematically illustrates a flow chart of a method for operating DFT according to some embodiments of the present disclosure;

FIG. 15 schematically illustrates results of CM simulation on non-DFT scheme and different DFT operation schemes according to some embodiments of the present disclosure;

FIG. 16 schematically illustrates a block diagram of an apparatus for uplink resource mapping at a terminal device in a wireless communication system according to some embodiments of the present disclosure;

FIG. 17 schematically illustrates a block diagram of an apparatus for uplink resource mapping at a terminal device in a wireless communication system according to some embodiments of the present disclosure;

FIG. 18 schematically illustrates a block diagram of an apparatus for operating DFT at a terminal device in a wireless communication system according to some; and

FIG. 19 schematically illustrates a simplified block diagram of an apparatus 1910 that may be embodied as or comprised in a terminal device like UE, and an apparatus 1920 that may be embodied as or comprised in a network device like gNB as described herein.

### DETAILED DESCRIPTION OF EMBODIMENTS

Hereinafter, the solutions as provided in the present disclosure will be described in details through embodiments with reference to the accompanying drawings. It should be appreciated that these embodiments are presented only to enable those skilled in the art to better understand and implement the present disclosure, not intended to limit the scope of the present disclosure in any manner. For example, features illustrated or described as part of one embodiment may be used with another embodiment to yield still a further embodiment. In the interest of clarity, not all features of an actual implementation are described in this specification.

In the accompanying drawings, various embodiments of the present disclosure are illustrated in block diagrams, flow charts and other diagrams. Each block in the flowcharts or blocks may represent a module, a program, or a part of code, which contains one or more executable instructions for performing specified logic functions, and in the present disclosure, a dispensable block is illustrated in a dotted line. Besides, although these blocks are illustrated in particular sequences for performing the steps of the methods, as a matter of fact, they may not necessarily be performed strictly according to the illustrated sequence. For example, they might be performed in reverse sequence or simultaneously, which is dependent on natures of respective operations. It should also be noted that block diagrams and/or each block in the flowcharts and a combination of thereof may be implemented by a dedicated hardware-based system for performing specified functions/operations or by a combination of dedicated hardware and computer instructions.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), wireless local area network (WLAN) standards, such as the IEEE 802.11 standards, and/or any other appropriate wireless communication standard either currently known or to be developed in the future.

As used herein, the term “network device” refers to a node in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communications. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “communication device”, “terminal”, “user equipment” and “UE” may be used interchangeably.

As yet another example, in an Internet of Things (TOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink (DL) transmission refers to a transmission from a network device to UE, and an uplink (UL) transmission refers to a transmission in an opposite direction.

As mentioned above, for the UL transmission in unlicensed carrier, the interlace-based resource mapping scheme is adopted for PUSCH to support FDM based multiplexing between UEs on the same subframe. According to this scheme, a frequency domain resource scheduling is achieved using interlaces, wherein an interlace is defined as a plurality of clusters each consisting of continuous subcarriers, and the plurality of clusters are uniformly distributed over the system bandwidth.

For illustrative purposes, FIG. 1 illustrates an example interlace for the UL PUSCH transmission on the unlicensed band in the prior art. As illustrated in FIG. 1, for the 20 MHZ transmission bandwidth with 100 RBs, there are illustrated 10 example clusters uniformly distributed over the system bandwidth, each cluster contains 12 subcarriers (i.e., one RB) and the 10 clusters form one interlace. The spacing between two adjacent clusters is a fixed value, i.e., 9 RBs. Thus, for the 20 MHZ bandwidth with 100 RBs, the first cluster in an interlace might be located at any of the first 10 RBs and thus there might 10 different interlaces and each interlace contains at most 10 RBs. In such a way, it could make sure that the bandwidth containing 99% of the power of the signal shall be between 80% and 100% of the declared nominal channel bandwidth, wherein the nominal channel bandwidth is defined as the widest band of frequencies, inclusive of guard bands, assigned to a single channel.

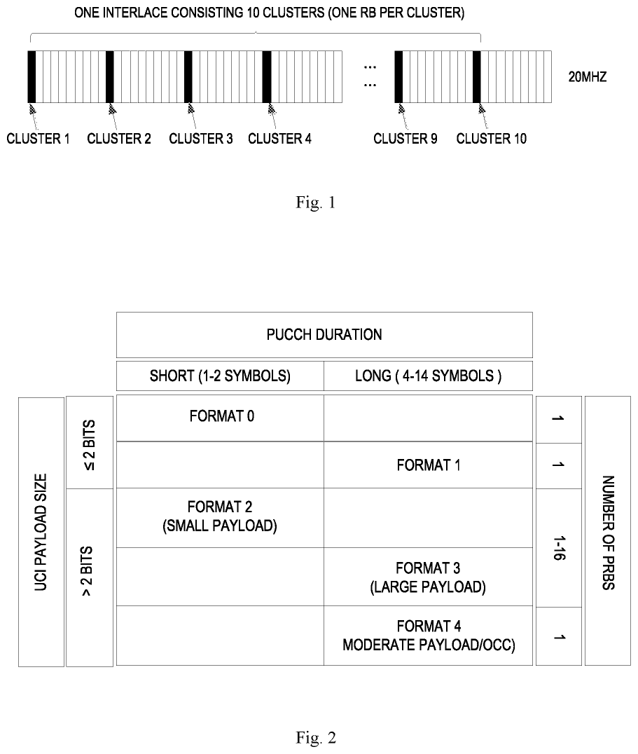

The NR-U shall support both short and long PUCCH to address different latency and coverage requirements, wherein the short PUCCH is critical for low latency and long PUCCH is beneficial for coverage related scenarios. In the current NR-U, there are defined five different formats for PUCCH, as illustrated in FIG. 2. As illustrated, in the five formats, Formats 0 and 1 have a Uplink Control Indication (UCI) payload size of <=2 bits, and Formats 2 to 5 have a UCI payload size of >2 bits; Formats 0 1, and 4, only one RB and Formats 2 and 3 may have 1 to 16 RBs.

For Formats 0, 1 and 4 with only one RB, to meet the OCB requirement, it also requires to adopt the interlaced structure to spread the one RB into for example 10 RBs equally spacing on the system bandwidth. A straightforward scheme is to repeat contents contained in one RB ten times in 10 RBs equally spaced on the system bandwidth. However, such a straightforward repetition scheme causes a high Cubic Metric (CM), which is unacceptable.

The CM is one of important design criterion of unlicensed bands, which is a metric of the actual reduction in power capability, or power de-rating, of a typical power amplifier. It is a more effective predictor than the peak-to-average power ratio (PAPR). The CM has a great influence on the uplink coverage and generally, the lower the value of CM is, the less the constraints on power amplifier design are. Thus, the high CM means strict constraints on the power amplifier design.

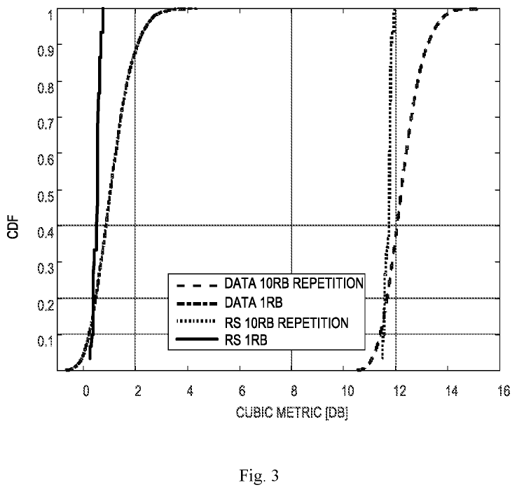

Only for illustrative purposes, FIG. 3 illustrates results of cubic metric (CM) simulation of data transmission and reference signal transmission in a straightforward repetition interlacing solution. From the illustrated simulation results, it can be seen that the CM of the straightforward repetition scheme is increased substantially compared to the original one-RB transmission for both the data and reference signals.

In addition, for PUSCH, in order to reduce the CM of data channel, it usually adopts Discrete Fourier Transform-Spread Orthogonal Frequency Division Multiplexing (DFT-s-OFDM) solution, wherein a DFT operation is performed before OFDM baseband signal generation, but the number of RBs can only involve factors of 2, 3, or 5 so that the fast algorithm can be utilized. This means that for NR-U with the maximum RB number of 106, the fast algorithm cannot be applied sometime since some of interlaces will have 11 clusters in one interlace.

In 3GPP technical document R1-1805921, there are proposed various designs for UL physical channels for UR-U. In the proposed design, it was proposed to use flexible interlaced design supporting both interlace with fixed cluster spacing and non-even interlace structure, support PUCCH formats of both 1-2 symbols and 4-14 symbols carrying more than 2 bits, confine NR-U PUCCH within the minimum nominal channel bandwidth, e.g. 20 MHz in 5 GHz, etc.

In 3GPP technical document R1-1807035, there are proposed serval design options for short PUCCH. In a first option, the short PUCCH is interlaced by means of two existing complementary QPSK sequences; in the second option, the short PUCCH is interlaced by means of a set of spreading sequences with minimum PAPR or minimum CM; in the third option, the short PUCCH is interlaced by means of simply repeating a reference signal generated from Zadoff-Chu (ZC) Sequences. However, these solutions have their own problems, such as, high computing resource consumption, non-scalable, high PAPR, increased receiver complexity, or bad cross correlation.

Embodiments of the present disclosure provide a new solution for uplink resource mapping in a wireless communication to mitigate or at least alleviate at least one of the above problems. In embodiments of the present disclosure, a scrambling sequence is used to scramble a reference signal sequence generated from a predetermined sequence group, so as to obtain another reference signal sequence complementary with the reference signal sequence. Then the two complementary reference signal sequences are mapped onto two different parts of a plurality of clusters in an interlace by spreading them with two complementary spreading sequences. By means of the two complementary reference signal sequences and two complementary spreading sequences, the two different parts of clusters could have complementary signal energy after DFT operation and thus have a lower CM as a whole.

Hereinafter, reference will be further made to accompanying drawings to describe the solutions as proposed in the present disclosure in details. However, it shall be appreciated that the following embodiments are given only for illustrative purposes and the present disclosure is not limited thereto.

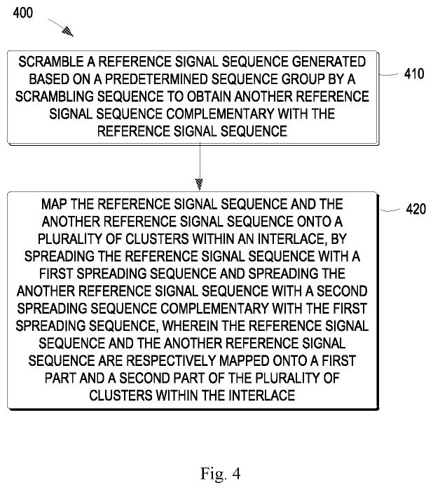

FIG. 4 schematically illustrates a flow chart of a method for uplink resource mapping in a wireless communication system according to some embodiments of the present disclosure. The method 400 can be implemented at a terminal device like UE or any other terminal device.

As illustrated in FIG. 4, in step 410, the terminal device may scramble a reference signal sequence generated based on a predetermined sequence group by a scrambling sequence to obtain another reference signal sequence complementary with the reference signal sequence.

The reference signal, for example may be demodulation reference signal or any other reference signals. For PUCCH formats with one RB span, the reference signals may be generated using a 12-length computer generated QPSK sequence.

According to the specification, for M_{ZC}∈{6,12,18,24} the base sequence is given by

r̅_{u,v}(n)=e^{jφ(n)π/4},0≤n≤M_{ZC}−1 Equation (1)

wherein Mzc indicates the length of the base sequence, u indicates an index sequence, u=0, . . . , 29; v=0 only; and φ(n) indicates a sequence corresponding to the sequence index u, n=0, . . . , 11, which can be given by a sequence table.

In the present disclosure, the value of Mzc is 12, the sequence index u can be configured for a serving cell by the network device and indicated to the terminal device within the cell. The sequence table can contain 30 sequence corresponding to indexes u=0 to 29. The sequence in the sequence table shall is a complementary sequence.

For a sequence x(n), its odd sequence (consisting of symbols with odd indices) is denoted as x1(m) and a Fourier Transform sequence of the odd sequence is denoted as X1(k); its even sequence (consisting of symbols with even indices) is denoted as x2(m) and it's Fourier transform sequence is denoted as X2(k). If for any k, X1(k)*X1(k)+X2(k)*X2(k) is a constant, then the sequence x(n) can be called as a complementary sequence. An example sequence table is provided as follows only for illustrative purposes:

TABLE 1
Definition of φ(n) for M_{ZC} = 12.

| | φ(n), n = 0, . . . 11 | | | | | | | | | | | |
|---|---|---|---|---|---|---|---|---|---|---|---|---|
| u | 0 | 1 | 2 | 3 | 4 | 5 | 6 | 7 | 8 | 9 | 10 | 11 |
| 0 | 3 | −3 | 3 | 1 | −1 | 1 | 1 | −1 | −1 | 1 | 3 | 1 |
| 1 | −1 | 1 | 1 | −3 | −1 | −3 | −1 | 1 | −1 | −1 | 3 | 1 |
| 2 | −1 | −3 | 1 | 1 | −1 | 1 | 3 | 1 | 3 | −1 | −1 | 1 |
| 3 | −1 | −3 | −1 | 3 | 3 | −3 | −1 | −3 | 1 | 1 | −1 | 1 |
| 4 | 1 | −3 | −3 | 1 | −1 | 1 | −3 | 3 | 1 | 1 | 1 | 1 |
| 5 | 1 | 1 | 1 | 1 | −1 | −3 | 1 | 3 | 1 | −3 | −3 | 1 |
| 6 | −1 | 1 | −1 | −1 | 3 | 1 | 3 | −3 | −3 | 1 | 3 | 1 |
| 7 | 3 | 1 | 3 | −3 | 1 | −1 | 3 | −3 | 3 | 1 | −1 | 1 |
| 8 | 3 | −3 | 3 | 1 | −1 | 1 | −3 | 3 | −1 | 1 | 3 | 1 |
| 9 | 3 | 1 | 3 | −3 | −3 | 3 | 3 | −3 | 3 | 1 | −1 | 1 |
| 10 | −3 | −3 | 1 | 1 | −1 | 1 | 1 | −1 | −3 | 1 | −3 | 1 |
| 11 | 1 | 1 | 3 | 3 | 1 | 1 | 1 | −3 | 1 | −3 | −3 | 1 |
| 12 | 1 | 1 | −3 | −3 | 1 | −1 | −1 | 1 | −3 | 1 | −3 | 1 |
| 13 | 1 | −3 | 1 | −3 | 1 | 3 | 3 | 1 | −3 | −3 | 1 | 1 |
| 14 | −3 | −3 | 1 | 1 | 1 | 1 | −3 | 1 | 3 | −1 | −3 | 1 |
| 15 | −3 | −3 | −3 | −3 | 1 | 1 | −3 | 1 | −1 | 3 | −3 | 1 |
| 16 | −3 | 1 | −3 | 1 | −1 | −3 | −3 | −1 | −3 | −3 | 1 | 1 |
| 17 | 1 | −3 | −3 | 1 | −3 | 1 | 1 | 1 | 3 | 3 | 1 | 1 |
| 18 | 1 | −3 | 1 | −3 | −3 | 1 | 1 | 1 | −1 | −1 | 1 | 1 |
| 19 | 1 | 1 | −1 | −1 | 1 | 1 | 1 | −3 | −3 | 1 | −3 | 1 |
| 20 | −3 | 1 | −1 | 3 | −3 | 1 | −3 | −3 | 1 | 1 | 1 | 1 |
| 21 | −3 | 1 | 3 | −1 | −3 | 1 | −3 | −3 | −3 | −3 | 1 | 1 |
| 22 | −3 | −3 | −3 | −3 | −3 | −1 | 3 | 1 | 1 | −3 | −3 | 1 |
| 23 | −1 | −3 | −1 | −1 | 3 | −3 | −1 | −3 | −3 | 1 | −1 | 1 |
| 24 | 3 | 1 | 3 | −3 | −3 | 3 | −1 | 1 | 3 | 1 | −1 | 1 |
| 25 | 3 | −3 | 3 | 1 | 3 | −3 | 1 | −1 | −1 | 1 | 3 | 1 |
| 26 | 3 | −3 | 3 | 1 | 3 | −3 | −3 | 3 | −1 | 1 | 3 | 1 |
| 27 | 3 | 1 | 3 | −3 | 1 | −1 | −1 | 1 | 3 | 1 | −1 | 1 |
| 28 | −1 | 1 | −1 | 3 | 3 | 1 | 3 | −3 | 1 | 1 | 3 | 1 |
| 29 | −3 | 1 | 1 | −3 | −3 | 3 | −1 | 1 | 1 | 1 | 1 | 1 |

wherein u indicates a sequence index and φ(n) indicates a sequence corresponding to the sequence index u, n=0, . . . , 11. It shall be appreciated that the above sequence table is only given for illustrative purposes, and the present application is not limited thereto. For example, the sequences can be phase shifted by a predetermined amount to obtain a new sequence table, but the complementary property still can be maintained. In addition, it may also possible to find another sequence table with complementary sequences.

Thus, the odd part after Fourier transformation and the even part of Fourier transformation are complementary and thus it can derive that for the whole sequence after Fourier transformation, the first half and second half are complementary.

Based on the sequence index u, it could determine a corresponding T(n) from Table 1 and then it may generate a reference signal sequence further based on the above equation (1). After that, the generated reference signal sequence can be further scrambled by a scrambling sequence to obtain another reference signal sequence complementary with the reference signal sequence. One of example scrambling sequences is [1, −1, 1, −1, 1, −1, 1, −1, 1, −1, 1, −1]. For the scrambled reference signal sequence, after the Fourier Transform, its first half equals to a second half of that of the reference signal sequence generated based on the above equation and its second half equals to a first half of that of the generated reference signal sequence. Thus, the two reference signal sequences are complementary as well.

Next, in step 420, the reference signal sequence and the another reference signal sequence complementary therewith are mapped onto a plurality of clusters within an interlace by spreading the reference signal sequence with a first spreading sequence and spreading the another reference signal sequence with a second spreading sequence with the first spreading sequence, wherein the reference signal sequence and the another reference signal sequence are respectively mapped onto a first part and a second part of the plurality of clusters within an interlace. In a nutshell, the two complementary reference signal sequences are spreaded respectively with two complementary spreading sequences to map them onto a first half and a second half of the clusters.

For the transmission bandwidth of 20 MHz, the number of clusters in one interlace is 10 and each of the two spreading sequence may have a length of 5. Thus, the first spreading sequence can be used to spread the reference signal sequence onto 5 clusters and the second spreading sequence can be used to spread the another reference signal sequence onto the remaining 5 clusters.

In some embodiments of the present disclosure, the two spreading sequences may be two predetermined spreading sequences. In other words, the two spreading sequences can be two fixed sequences which can be applied for any reference signal sequence.

In some embodiments of the present disclosure, the two spreading sequences may be determined from a spreading sequence table based on a sequence index of the reference signal sequence. That is to say, for different reference signal sequences, the spreading sequence might be different. For illustrative purposes, Table 2 illustrates an example spreading sequence table.

TABLE 2
Definition of spreading sequence table

| | a5 | | | | | b5 | | | | |
|---|---|---|---|---|---|---|---|---|---|---|
| | 0 | 1 | 2 | 3 | 4 | 0 | 1 | 2 | 3 | 4 |
| mod(u, 2) = = 0 | 1 | −i | −1 | −1 | −i | i | −i | i | −1 | −1 |
| mod(u, 2) = = 1 | 1 | i | −1 | −1 | i | −i | i | −i | −1 | −1 |

wherein a5 indicates a spreading sequence of length of 5 for the generated reference signal sequence and b5 indicates a spreading sequence of length of 5 for the another scrambled reference signal sequence, and mod (x, y) indicate the remainder obtained from dividing x by y. From the example table, it can be seen that the terminal device may first determine the value of mod (u, 2) and then select the first and second spreading sequences from the table based on the determined value. For the sequence table illustrated in Table 2, it means that the first and second spreading sequences for reference signal sequences with an odd sequence indices are different from those with even sequence indices. By using such table sequence table, it could achieve better transmission performance, for example lower CM, although the fixed spreading sequences can already achieve a good CM.

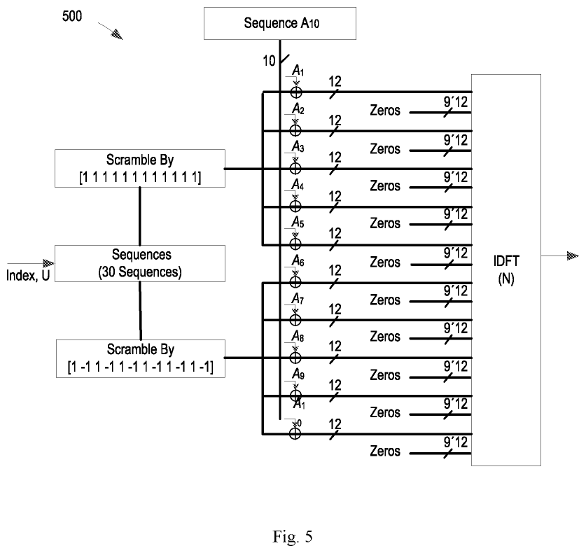

FIG. 5 illustrates a block diagram of a system for uplink resource mapping in a wireless communication system according to some embodiments of the present disclosure. The system 500 can be implemented at can be implemented at a terminal device like UE or any other terminal device.

As illustrated in FIG. 5, for an index u, the terminal device may first select one sequence from the group table of 30 sequences as illustrated in Table 1 based on the value of index u. Then, the terminal device may generate a corresponding reference signal sequence based on for example equation (1). For the generated reference signal sequence, the terminal device may scramble it by a scrambling sequence such as [1, −1, 1, −1, 1, −1, 1, −1, 1, −1, 1, −1], to obtain another reference signal sequence complementary with the reference signal sequence. The reference signal sequence is also scrambled by [1, 1, 1, 1, 1, 1, 1, 1, 1, 1, 1, 1], which means that the reference signal sequence will be kept as it is. Next, the sequence scrambled by [1, 1, 1, 1, 1, 1, 1, 1, 1, 1, 1, 1] is spreaded by a₁ to a₅ (a5 in Table 2) and the sequence scrambled by [1, −1, 1, −1, 1, −1, 1, −1, 1, −1, 1, −1] is spreaded by a6 to a₁₀ (b5 in Table 2). Meanwhile, RBs between these clusters are padded with zeros. Thereafter, Inverse Discrete Fourier Transformation (IDFT) is performed thereon. In such a way, it could achieve the resource mapping from one RB onto 10 RBs.

It shall be appreciated that in the solution as illustrated in FIG. 5, the originally generated reference signal sequence are mapped onto the first half of the clusters within one interlace and the scrambled reference signal sequence is mapped onto the second half of the clusters within the interlace, but the present disclosure is not limited thereto. Practically, it is also possible to map the originally generated reference signal sequence onto the second half of the clusters and map the scrambled reference signal sequence onto the first half of the clusters, or map them onto the even numbered clusters and the odd numbered clusters respectively, as long as the corresponding spreading sequence are modified accordingly.

For resource mapping of the one-RB PUCCH, there are also some other alternative options, which will be further described hereinafter.

Option 1:

In Option 1, reference signal sequences of length 120 defined in the NR specification may be used and mapping the reference signal sequences from one RB onto 10 RBs.

Option 2:

In Option 2, reference signal sequences of length of 12 defined in the NR specification may be used and the reference signal sequences may be mapped from one RB onto 10 RBs by means of self-spreading. The term “self-spreading” here means using a predefined sequence from the sequence table for the reference signal as a spreading sequence to block spread the reference signal sequence generated based on the sequence table. For illustrative purposes, Table 3 illustrates the sequence tables for length 12 specified in the current specification.

TABLE 3
Definition of φ(n) for M_{ZC} = 12

| | φ(n), n = 0, . . . 11 | | | | | | | | | | | |
|---|---|---|---|---|---|---|---|---|---|---|---|---|
| 0 | −3 | 1 | −3 | −3 | −3 | 3 | −3 | −1 | 1 | 1 | 1 | −3 |
| 1 | −3 | 3 | 1 | −3 | 1 | 3 | −1 | −1 | 1 | 3 | 3 | 3 |
| 2 | −3 | 3 | 3 | 1 | −3 | 3 | −1 | 1 | 3 | −3 | 3 | −3 |
| 3 | −3 | −3 | −1 | 3 | 3 | 3 | −3 | 3 | −3 | 1 | −1 | −3 |
| 4 | −3 | −1 | −1 | 1 | 3 | 1 | 1 | −1 | 1 | −1 | −3 | 1 |
| 5 | −3 | −3 | 3 | 1 | −3 | −3 | −3 | −1 | 3 | −1 | 1 | 3 |
| 6 | 1 | −1 | 3 | −1 | −1 | −1 | −3 | −1 | 1 | 1 | 1 | −3 |
| 7 | −1 | −3 | 3 | −1 | −3 | −3 | −3 | −1 | 1 | −1 | 1 | −3 |
| 8 | −3 | −1 | 3 | 1 | −3 | −1 | −3 | 3 | 1 | 3 | 3 | 1 |
| 9 | −3 | −1 | −1 | −3 | −3 | −1 | −3 | 3 | 1 | 3 | −1 | −3 |
| 10 | −3 | 3 | −3 | 3 | 3 | −3 | −1 | −1 | 3 | 3 | 1 | −3 |
| 11 | −3 | −1 | −3 | −1 | −1 | −3 | 3 | 3 | −1 | −1 | 1 | −3 |
| 12 | −3 | −1 | 3 | −3 | −3 | −1 | −3 | 1 | −1 | −3 | 3 | 3 |
| 13 | −3 | 1 | −1 | −1 | 3 | 3 | −3 | −1 | −1 | −3 | −1 | −3 |
| 14 | 1 | 3 | −3 | 1 | 3 | 3 | 3 | 1 | −1 | 1 | −1 | 3 |
| 15 | −3 | 1 | 3 | −1 | −1 | −3 | −3 | −1 | −1 | 3 | 1 | −3 |
| 16 | −1 | −1 | −1 | −1 | 1 | −3 | −1 | 3 | 3 | −1 | −3 | 1 |
| 17 | −1 | 1 | 1 | −1 | 1 | 3 | 3 | −1 | −1 | −3 | 1 | −3 |
| 18 | −3 | 1 | 3 | 3 | −1 | −1 | −3 | 3 | 3 | −3 | 3 | −3 |
| 19 | −3 | −3 | 3 | −3 | −1 | 3 | 3 | 3 | −1 | −3 | 1 | −3 |
| 20 | 3 | 1 | 3 | 1 | 3 | −3 | −1 | 1 | 3 | 1 | −1 | −3 |
| 21 | −3 | 3 | 1 | 3 | −3 | 1 | 1 | 1 | 1 | 3 | −3 | 3 |
| 22 | −3 | 3 | 3 | 3 | −1 | −3 | −3 | −1 | −3 | 1 | 3 | −3 |
| 23 | 3 | −1 | −3 | 3 | −3 | −1 | 3 | 3 | 3 | −3 | −1 | −3 |
| 24 | −3 | −1 | 1 | −3 | 1 | 3 | 3 | 3 | −1 | −3 | 3 | 3 |
| 25 | −3 | 3 | 1 | −1 | 3 | 3 | −3 | 1 | −1 | 1 | −1 | 1 |
| 26 | −1 | 1 | 3 | −3 | 1 | −1 | 1 | −1 | −1 | −3 | 1 | −1 |
| 27 | −3 | −3 | 3 | 3 | 3 | −3 | −1 | 1 | −3 | 3 | 1 | −3 |
| 28 | 1 | −1 | 3 | 1 | 1 | −1 | −1 | −1 | 1 | 3 | −3 | 1 |
| 29 | −3 | 3 | −3 | 3 | −3 | −3 | 3 | −1 | −1 | 1 | 3 | −3 |
| 30 | −3 | 1 | −3 | −3 | −3 | 3 | −3 | −1 | 1 | 1 | 1 | −3 |

Through the computer searching, it may found from the 30 sequences, the sequence corresponding to u=2 could achieve acceptable performance with its first ten symbols.

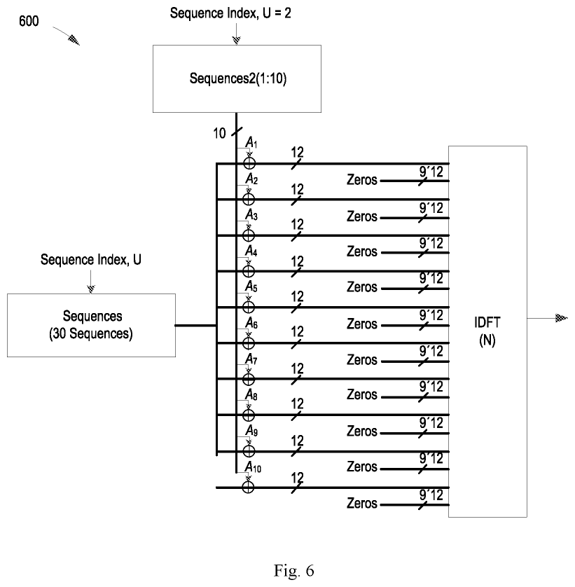

FIG. 6 illustrates a block diagram of another system for uplink resource mapping in a wireless communication system according to some embodiments of the present disclosure. The system 600 can be implemented at a terminal device like UE or any other terminal device. As illustrated in FIG. 6, for an index u, the terminal device may first select one sequence from the group of 30 sequences as illustrated in

Table 3 based on the value of index u. Then, the terminal device may generate a corresponding reference signal sequence based on for example equation (1). Next, the generated signal sequence is spreaded by the first ten symbols of a sequence with u=2, i.e., [−3, 3, 3, 1, −3, 3, −1, 1, 3, −3] (a1 to a10). Those RBs between these clusters are padded with zeros. Thereafter, IDFT is performed thereon. In such a way, it could also achieve the resource mapping from one RB onto 10 RBs.

Option 3:

In Option 3, reference signal sequences of length 12 defined in the NR specification may be used and the reference signal sequences may be mapped from one RB onto 10 RBs by means of a Zadoff-Chu (ZC) sequence of length 10. In other words, the sequences in Table 3 are reused, and instead of a self-spreaded sequence, a ZC sequence is used to spread the reference signal sequence onto the ten clusters. An example of ZC sequence can be provided as follows:

aₙ=exp(j*2*pi*n*(n+1)/10) Equation (2)

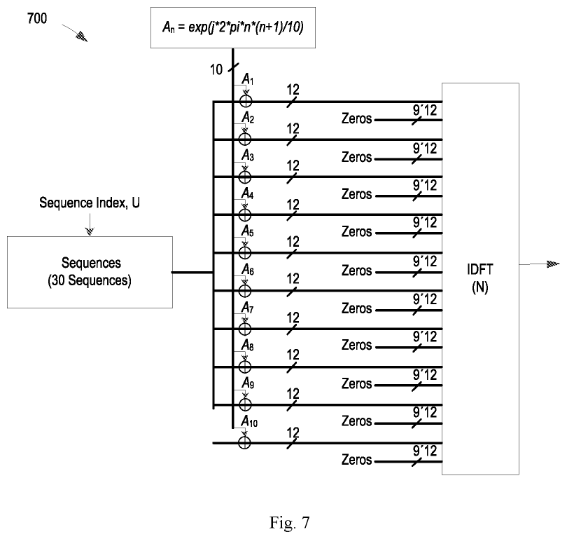

FIG. 7 illustrates a block diagram of a further system for uplink resource mapping in a wireless communication system according to some embodiments of the present disclosure. The system 700 can be implemented at can be implemented at a terminal device like UE or any other terminal device. As illustrated in FIG. 7, for an index u, the terminal device may first select one sequence from the group of 30 sequences as illustrated in Table 3 based on the value of index u. Then, the terminal device may generate a corresponding reference signal sequence based on for example equation (1). Next, the generated signal sequence is spreaded by a spreading sequence of symbols a1 to a10, which is a ZC sequence generated based on for example equation (2). RBs between these clusters are padded with zeros. Thereafter, IDFT is performed thereon. In such a way, it could also achieve the resource mapping from one RB onto 10 RB.

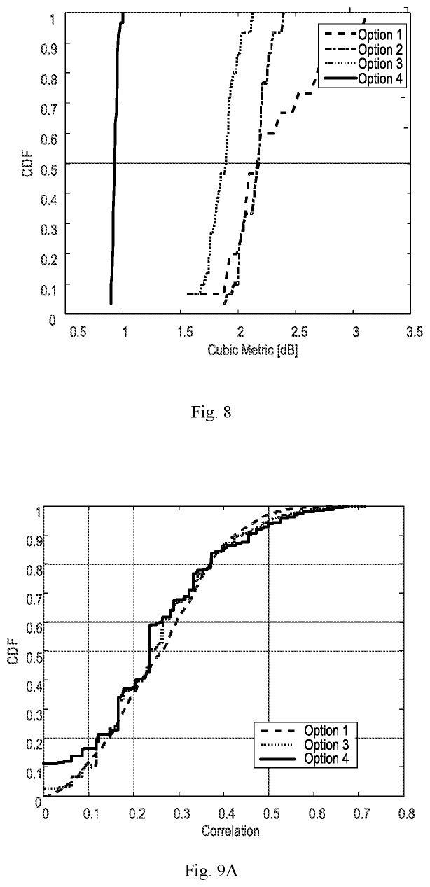

FIG. 8 illustrates results of CM simulation on various options described above (the solution described with reference to FIGS. 4 and 5 is denoted as Option 4). As illustrated in FIG. 8, it can be seen that each of four options can achieve a CM lower than 3.5 and Option 4 even has a CM of lower than 1 dB, which is decreased substantially compared to the CM value (near 12) for RS of the straightforward repetition scheme as illustrated in FIG. 3.

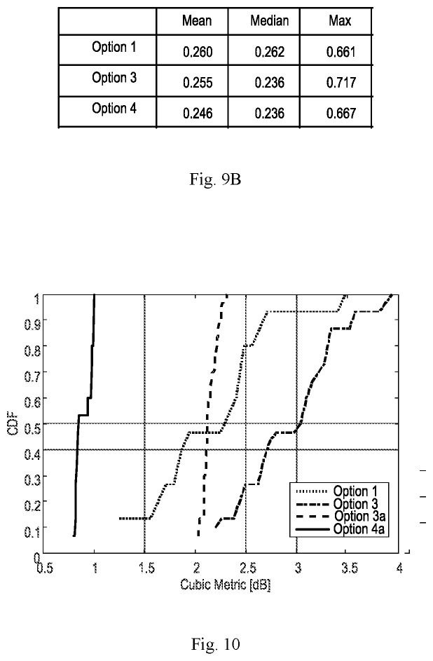

FIGS. 9A and 8B illustrates results of correlation simulation on options described above (the solution described with reference to FIGS. 4 and 5 is denoted as Option 4). From FIGS. 9A and 9B, it can be see that Options 1, 3, and 4 have similar correlation performance.

It shall be appreciated that the sequence group illustrated in Table 1 is only an example and it is also possible to adopt another sequence group. Table 4 illustrates another example sequence group that can be used in embodiments of the present disclosure.

TABLE 4
Definition of φ(n) for M_{ZC} = 12

| | φ(n), n = 0, . . . 11 | | | | | | | | | | | |
|---|---|---|---|---|---|---|---|---|---|---|---|---|
| u | 0 | 1 | 2 | 3 | 4 | 5 | 6 | 7 | 8 | 9 | 10 | 11 |
| 0 | 1 | −3 | 1 | 3 | −3 | −3 | 1 | −3 | 3 | 1 | 1 | 1 |
| 1 | 1 | −3 | 1 | 3 | −3 | −3 | −3 | 1 | −1 | −3 | −3 | −3 |
| 2 | 1 | −3 | −1 | −3 | 1 | 1 | 1 | −3 | −3 | −1 | −3 | −3 |
| 3 | 1 | −3 | −1 | −3 | 1 | 1 | −3 | 1 | 1 | 3 | 1 | 1 |
| 4 | 1 | −3 | 3 | −3 | 1 | 1 | 3 | −1 | −1 | −3 | −1 | −1 |
| 5 | 1 | −3 | 3 | −3 | 1 | 1 | −1 | 3 | 3 | 1 | 3 | 3 |
| 6 | 1 | 1 | −1 | 1 | 1 | −3 | 1 | −3 | −1 | −3 | 1 | 1 |
| 7 | 1 | 1 | −1 | 1 | 1 | −3 | −3 | 1 | 3 | 1 | −3 | −3 |
| 8 | 1 | −3 | −3 | 1 | −1 | 1 | 1 | −3 | −3 | −3 | 3 | −3 |
| 9 | 1 | −3 | −3 | 1 | −1 | 1 | −3 | 1 | 1 | 1 | −1 | 1 |
| 10 | 1 | 1 | −3 | 1 | 3 | 1 | 1 | −1 | 1 | 1 | −3 | −3 |
| 11 | 1 | 1 | −3 | 1 | 3 | 1 | −3 | 3 | −3 | −3 | 1 | 1 |
| 12 | 1 | 3 | 1 | 1 | 1 | −3 | 1 | 3 | 1 | −3 | −3 | 1 |
| 13 | 1 | 3 | 1 | 1 | 1 | −3 | −3 | −1 | −3 | 1 | 1 | −3 |
| 14 | 1 | 1 | −3 | −3 | −1 | −3 | 1 | −1 | 1 | −3 | 1 | 1 |
| 15 | 1 | 1 | −3 | −3 | −1 | −3 | −3 | 3 | −3 | 1 | −3 | −3 |
| 16 | 1 | 3 | 1 | −3 | −3 | 1 | 1 | −3 | −3 | −3 | 3 | −3 |
| 17 | 1 | 3 | 1 | −3 | −3 | 1 | −3 | 1 | 1 | 1 | −1 | 1 |
| 18 | 1 | 3 | 1 | 1 | 1 | −3 | 1 | −3 | −3 | 1 | −1 | 1 |
| 19 | 1 | 3 | 1 | 1 | 1 | −3 | −3 | 1 | 1 | −3 | 3 | −3 |
| 20 | 1 | 1 | −3 | 3 | −3 | 1 | 1 | −3 | −3 | −1 | −3 | −3 |
| 21 | 1 | 1 | −3 | 3 | −3 | 1 | −3 | 1 | 1 | 3 | 1 | 1 |
| 22 | 1 | 1 | −3 | 1 | 3 | 1 | 3 | 3 | −1 | −1 | 1 | −1 |
| 23 | 1 | 1 | −3 | 1 | 3 | 1 | −1 | −1 | 3 | 3 | −3 | 3 |
| 24 | 1 | −3 | 1 | −1 | −3 | −3 | 3 | −1 | 1 | 3 | 3 | 3 |
| 25 | 1 | −3 | 1 | −1 | −3 | −3 | −1 | 3 | −3 | −1 | −1 | −1 |
| 26 | 1 | −1 | 1 | 1 | −3 | −3 | 3 | 1 | 3 | −1 | 3 | 3 |
| 27 | 1 | −1 | 1 | 1 | −3 | −3 | −1 | −3 | −1 | 3 | −1 | −1 |
| 28 | 1 | 1 | 1 | −1 | −3 | 1 | 3 | −1 | 3 | −3 | −1 | −1 |
| 29 | 1 | 1 | 1 | −1 | −3 | 1 | −1 | 3 | −1 | 1 | 3 | 3 |

In each sequence of the sequence table as illustrated in Table 4, each of the first half and the second half of the sequence is complementary but after Fourier transform of sequence of group1, there is no complementary property.

Based on the sequence index u, it could determine a corresponding φ(n) from Table 4 and it may be generated a reference signal sequence further based on the above equation (1). Then, the generated reference signal sequence can be further scrambled by a scrambling sequence to obtain another reference signal sequence complementary with the reference signal sequence. One of example scrambling sequences is [1, 1, 1, 1, 1, 1, −1, −1, −1, −1, −1, −1]. For the scrambled reference signal sequence, after the Fourier Transform, its first half equals to a second half of that of the originally generated reference signal sequence and its second half equals to a first half of that of the reference signal sequence. Thus, the two reference signal sequences are complementary.

In addition, for the sequence table as illustrated in Table 4, it is possible introduce a sub-RB based solution for, for example, 60 KHz subcarrier spacing. That is to say, it may use a 6-length sequence of NR and spread the sequence by a 20-length spreading sequence.

FIG. 10 illustrates results of CM simulation on options described above (the sub-RB based solution is denoted as Option 3a, and the solution using Table 4 is denoted as Option 4a). From FIG. 8, it can be seen that Option 3a can achieve a CM better than Options 1 and 3 and the Option 4a may also has a CM lower than 1, which is decreased substantially compared to the CM value (near 12) for RS of the straightforward repetition scheme as illustrated in FIG. 3.

For the system bandwidth of 40 MHz or 80 MHz, the number of clusters might be 20 or 40. Thus, the spreading sequences shall be longer. In such a case, it is to determine spreading sequences for the transmission bandwidth of 40 MHz or 80 MHz. In some embodiments of the present disclosure, it is possible to determine them by computer searching.

In another aspect of the present disclosure, it is proposed to determine one or both of the first spreading sequence and the second spreading sequence based on a first basic spreading sequence and a second basic spreading sequence. The first basic spreading sequence and the second basic spreading sequence may be, for example, those spreading sequences (a5 and b5) for a system bandwidth of 20 MHz.

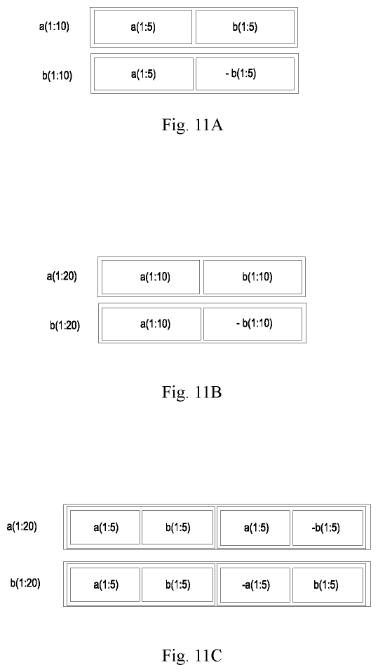

In some embodiments of the present disclosure, a first spreading sequence a10 for a system bandwidth of 40 MHz may be formed by cascading the first basic spreading sequence a5 and the second basic spreading sequence b5; and wherein a second spreading sequence b10 for the system bandwidth of 40 MHz may be formed by cascading the first basic spreading sequence a5 and a negative sequence −b5 of the second basic spreading sequence, as illustrated in FIG. 11A.

In some embodiments of the present disclosure, a first spreading sequence a20 for a system bandwidth of 80 MHz may be formed by cascading the first basic spreading sequence a10 and the second basic spreading sequence b10; and

wherein a second spreading sequence b20 for the system bandwidth of 80 MHz may be formed by cascading the first basic spreading sequence a10 and a negative sequence −b10 of the second basic spreading sequence, as illustrated in FIG. 11B. In other words, it may determine the first and second spreading sequences for the transmission bandwidth of 80 MHz from those for the transmission bandwidth of 40 MHz in a way similar to that of determining the first and second spreading sequences for the transmission bandwidth of 40 MHz from those for the transmission bandwidth of 20 MHz.

In some embodiments of the present disclosure, a first spreading sequence a20 for a system bandwidth of 80 MHz may be formed by cascading a concatenation of the first basic spreading sequence a5 and the second basic spreading sequence b5 and a concatenation of the first basic spreading sequence a5 and a negative sequence −b5 of the second basic spreading sequence; and wherein a second spreading sequence b20 for the system bandwidth of 80 MHz may be formed by cascading a concatenation of the first basic spreading sequence a5 and the second basic spreading sequence b5 and a concatenation a negative sequence −a5 of the first basic spreading sequence and the second basic spreading sequence b5, as illustrated in FIG. 11C. That is to say, the first and second spreading sequences for the transmission bandwidth of 80 MHz can be determined directly from those for the transmission bandwidth of 20 MHz.

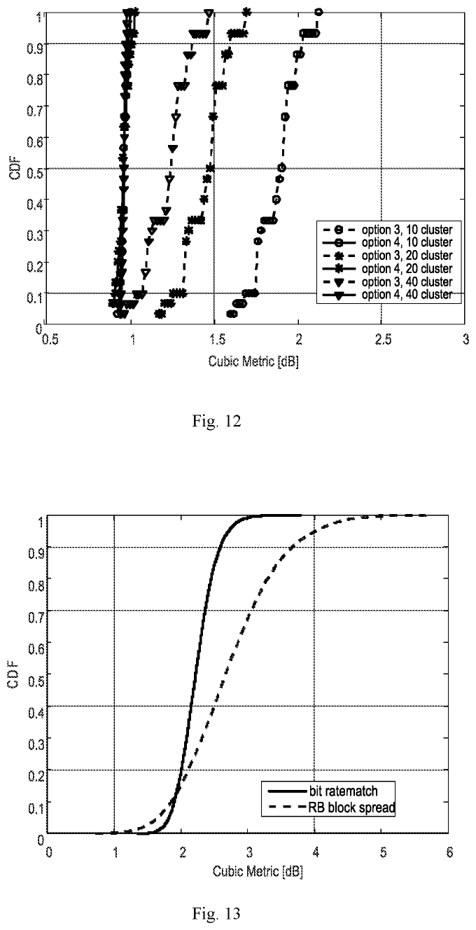

FIG. 12 schematically illustrates results of CM simulation on different spreading sequence determination schemes according to some embodiments of the present disclosure. From FIG. 12, it can be seen that even for the 20 clusters and 40 clusters, the CM is still lower than 2.5, which means spreading sequence determination schemes as illustrated in FIGS. 11A to 11C could have a stable CM performance.

For data symbols on one-RB PUCCH, n transport block bits are needed to be encoded to m modulation bits. In a further aspect of the present disclosure, there are provided two schemes to implement the resource mapping.

In a first scheme, the one-RB Physical Uplink Control Channel (PUCCH) may be mapped onto a plurality of clusters within one interlace by spreading the one-RB PUCCH with a third spreading sequence. That is to say, instead of the straightforward repetition, a designed spreading sequence a_i (i=0 to 9 for the transmission bandwidth of 20 MHz) will be used and the encoded signal is obtained by multiplying a_i with the original RB.

In a second scheme, the one-RB Physical Uplink Control Channel (PUCCH) may be mapped onto a plurality of clusters within one interlace by performing a rate matching on the one-RB PUCCH. That is to say, the n transport block bits are rate matched into 10*modulation bits which are corresponding to 10 RBs. The rate matching may use any existing method, for details, please see 3GPP TS38.212. Section 5.4.

FIG. 13 schematically illustrates results of CM simulation on RB block spreading and bit rate matching according to some embodiments of the present disclosure. From FIG. 13, it can be seen that the bit rate matching scheme has a better CM performance and thus it may be a better choice.

In addition, it is possible to introduce Orthogonal Cover Code (OCC) like PUCCH format 4 in the interlaced structure to allow UE multiplexing on orthogonal code domain. For the resource mapping on one RB, the one RB is multiplexed by two users using different OCCs; similarly, for resource mapping on ten RBs in the present disclosure, the ten RBs can be multiplexed by two users using two different OCCs too.

As mentioned for the PUSCH, only the DFT operations involving factors of 2, 3, or 5 are allowed so that the fast algorithm can be utilized. To use all of 106 RBs in NR-U and maintain 10 interlaces, there will be 11 RBs in some interlaces and 10 RBs in the other interlaces in a case of assuming equally 10 RB spacing within each interlace. This means that the fast algorithm cannot be applied although DFT is useful to reduce CM. To address this issue, it is proposed to perform two DFTs for the 11-RB scenario.

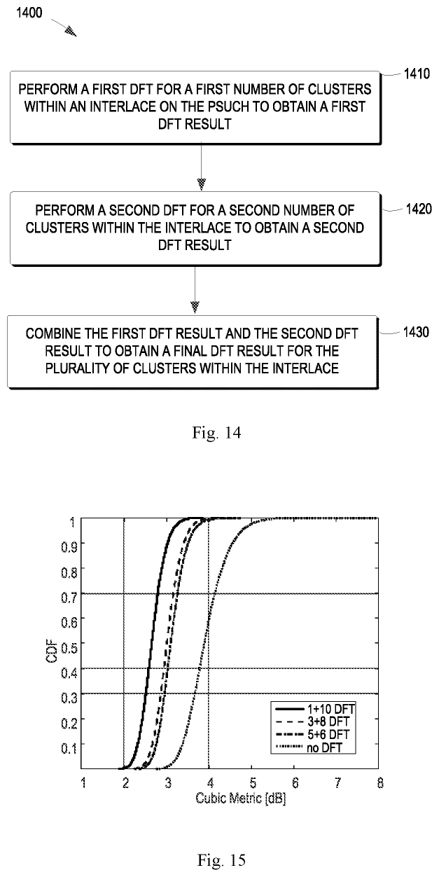

FIG. 14 illustrates a flow chart of resource mapping of PUSCH according to some embodiments of the present disclosure. As illustrated in FIG. 14, in step 1410, the terminal device may first perform a DFT for a first number of clusters within an interlace on the PSUCH to obtain a first DFT result. In step 1420, the terminal device may perform a second DFT for a second number of clusters within the interlace to obtain a second DFT result. In step 1430, the terminal device may combine the first DFT result and the second DFT result to obtain a final DFT result for the plurality of clusters within the interlace.

For example, it may perform two DFTs in a one-plus-ten mode, which means for the first RB, it may perform DFT one a DFT with a length of 12 on 12 subcarrier, while for the remaining 10 RB, it may perform a DFT with a length of 120. In addition, it is possible to consider DFTs in a two-plus-nine mode, in a three-plus-eight mode, in a five-plus-six mode, which could all involve only factors 2, 3, and 5.

FIG. 15 schematically illustrates results of CM simulation on non-DFT scheme and different DFT operation schemes according to some embodiments of the present disclosure. From FIG. 15, it can be seen that each of the above-mentioned DFT modes can achieve a better CM than the non-DFT case and the one-plus-ten mode could achieve better CM performance than other modes.

Hereinabove, the solutions of the present disclosure performed at the terminal device are described with reference to FIGS. 4 to 15. At the network device, the network device may receive the uplink signals transmitted in the interlaced structure according to embodiments of the present disclosure described in different aspects and decode the signals by mean of foe example non-coherent detection. Operations at the network device are corresponding to those at the terminal device and thus for some details of operations, one may refer to description with reference to FIGS. 4 to 15.

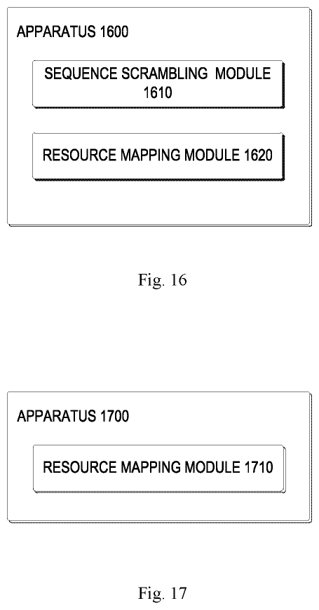

FIG. 16 schematically illustrates a block diagram of an apparatus for uplink resource mapping in a wireless communication system according to some embodiments of the present disclosure. The apparatus 1600 can be implemented at a terminal device or any other terminal device.

As illustrated in FIG. 16, the apparatus 1600 may include a sequence scrambling module 1610 and a resource mapping module 1620. The sequence scrambling module 1610 may be configured to scramble a reference signal sequence generated based on a predetermined sequence group by a scrambling sequence to obtain another reference signal sequence complementary with the reference signal sequence. The resource mapping module 1620 may be configured to map the reference signal sequence and the another reference signal sequence onto a plurality of clusters within an interlace, by spreading the reference signal sequence with a first spreading sequence and spreading the another reference signal sequence with a second spreading sequence complementary with the first spreading sequence. The reference signal sequence and the another reference signal sequence are respectively mapped onto a first part and a second part of the plurality of clusters within an interlace.

In some embodiments of the present disclosure, the first spreading sequence and the second spreading sequence are two predetermined spreading sequences.

In some embodiments of the present disclosure, the first spreading sequence and the second spreading sequence are determined from a spreading sequence table based on a sequence index of the reference signal sequence.

In some embodiments of the present disclosure, the spreading sequence table may be:

| | a5 | | | | | b5 | | | | |
|---|---|---|---|---|---|---|---|---|---|---|
| | 0 | 1 | 2 | 3 | 4 | 0 | 1 | 2 | 3 | 4 |
| mod(u, 2) = = 0 | 1 | −i | −1 | −1 | −i | i | −i | i | −1 | −1 |
| mod(u, 2) = = 1 | 1 | i | −1 | −1 | i | −i | i | −i | −1 | −1 |

wherein u indicates a sequence index, a5 indicates the first spreading sequence and b5 indicates the second spreading sequence.

In some embodiments of the present disclosure, the predetermined sequence group may be based on the following sequence table:

| | φ(n), n = 0, . . . 11 | | | | | | | | | | | |
|---|---|---|---|---|---|---|---|---|---|---|---|---|
| u | 0 | 1 | 2 | 3 | 4 | 5 | 6 | 7 | 8 | 9 | 10 | 11 |
| 0 | 3 | −3 | 3 | 1 | −1 | 1 | 1 | −1 | −1 | 1 | 3 | 1 |
| 1 | −1 | 1 | 1 | −3 | −1 | −3 | −1 | 1 | −1 | −1 | 3 | 1 |
| 2 | −1 | −3 | 1 | 1 | −1 | 1 | 3 | 1 | 3 | −1 | −1 | 1 |
| 3 | −1 | −3 | −1 | 3 | 3 | −3 | −1 | −3 | 1 | 1 | −1 | 1 |
| 4 | 1 | −3 | −3 | 1 | −1 | 1 | −3 | 3 | 1 | 1 | 1 | 1 |
| 5 | 1 | 1 | 1 | 1 | −1 | −3 | 1 | 3 | 1 | −3 | −3 | 1 |
| 6 | −1 | 1 | −1 | −1 | 3 | 1 | 3 | −3 | −3 | 1 | 3 | 1 |
| 7 | 3 | 1 | 3 | −3 | 1 | −1 | 3 | −3 | 3 | 1 | −1 | 1 |
| 8 | 3 | −3 | 3 | 1 | −1 | 1 | −3 | 3 | −1 | 1 | 3 | 1 |
| 9 | 3 | 1 | 3 | −3 | −3 | 3 | 3 | −3 | 3 | 1 | −1 | 1 |
| 10 | −3 | −3 | 1 | 1 | −1 | 1 | 1 | −1 | −3 | 1 | −3 | 1 |
| 11 | 1 | 1 | 3 | 3 | 1 | 1 | 1 | −3 | 1 | −3 | −3 | 1 |
| 12 | 1 | 1 | −3 | −3 | 1 | −1 | −1 | 1 | −3 | 1 | −3 | 1 |
| 13 | 1 | −3 | 1 | −3 | 1 | 3 | 3 | 1 | −3 | −3 | 1 | 1 |
| 14 | −3 | −3 | 1 | 1 | 1 | 1 | −3 | 1 | 3 | −1 | −3 | 1 |
| 15 | −3 | −3 | −3 | −3 | 1 | 1 | −3 | 1 | −1 | 3 | −3 | 1 |
| 16 | −3 | 1 | −3 | 1 | −1 | −3 | −3 | −1 | −3 | −3 | 1 | 1 |
| 17 | 1 | −3 | −3 | 1 | −3 | 1 | 1 | 1 | 3 | 3 | 1 | 1 |
| 18 | 1 | −3 | 1 | −3 | −3 | 1 | 1 | 1 | −1 | −1 | 1 | 1 |
| 19 | 1 | 1 | −1 | −1 | 1 | 1 | 1 | −3 | −3 | 1 | −3 | 1 |
| 20 | −3 | 1 | −1 | 3 | −3 | 1 | −3 | −3 | 1 | 1 | 1 | 1 |
| 21 | −3 | 1 | 3 | −1 | −3 | 1 | −3 | −3 | −3 | −3 | 1 | 1 |
| 22 | −3 | −3 | −3 | −3 | −3 | −1 | 3 | 1 | 1 | −3 | −3 | 1 |
| 23 | −1 | −3 | −1 | −1 | 3 | −3 | −1 | −3 | −3 | 1 | −1 | 1 |
| 24 | 3 | 1 | 3 | −3 | −3 | 3 | −1 | 1 | 3 | 1 | −1 | 1 |
| 25 | 3 | −3 | 3 | 1 | 3 | −3 | 1 | −1 | −1 | 1 | 3 | 1 |
| 26 | 3 | −3 | 3 | 1 | 3 | −3 | −3 | 3 | −1 | 1 | 3 | 1 |
| 27 | 3 | 1 | 3 | −3 | 1 | −1 | −1 | 1 | 3 | 1 | −1 | 1 |
| 28 | −1 | 1 | −1 | 3 | 3 | 1 | 3 | −3 | 1 | 1 | 3 | 1 |
| 29 | −3 | 1 | 1 | −3 | −3 | 3 | −1 | 1 | 1 | 1 | 1 | 1 |

wherein u indicates a sequence index and φ(n) indicates a sequence corresponding to the sequence index u, n=0, . . . , 11, and wherein the scrambling sequence is [1, −1, 1, −1, 1, −1, 1, −1, 1, −1, 1, −1].

In some embodiments of the present disclosure, the predetermined sequence group may be based on the following sequence table:

| | φ(n), n = 0, . . . 11 | | | | | | | | | | | |
|---|---|---|---|---|---|---|---|---|---|---|---|---|
| u | 0 | 1 | 2 | 3 | 4 | 5 | 6 | 7 | 8 | 9 | 10 | 11 |
| 0 | 1 | −3 | 1 | 3 | −3 | −3 | 1 | −3 | 3 | 1 | 1 | 1 |
| 1 | 1 | −3 | 1 | 3 | −3 | −3 | −3 | 1 | −1 | −3 | −3 | −3 |
| 2 | 1 | −3 | −1 | −3 | 1 | 1 | 1 | −3 | −3 | −1 | −3 | −3 |
| 3 | 1 | −3 | −1 | −3 | 1 | 1 | −3 | 1 | 1 | 3 | 1 | 1 |
| 4 | 1 | −3 | 3 | −3 | 1 | 1 | 3 | −1 | −1 | −3 | −1 | −1 |
| 5 | 1 | −3 | 3 | −3 | 1 | 1 | −1 | 3 | 3 | 1 | 3 | 3 |
| 6 | 1 | 1 | −1 | 1 | 1 | −3 | 1 | −3 | −1 | −3 | 1 | 1 |
| 7 | 1 | 1 | −1 | 1 | 1 | −3 | −3 | 1 | 3 | 1 | −3 | −3 |
| 8 | 1 | −3 | −3 | 1 | −1 | 1 | 1 | −3 | −3 | −3 | 3 | −3 |
| 9 | 1 | −3 | −3 | 1 | −1 | 1 | −3 | 1 | 1 | 1 | −1 | 1 |
| 10 | 1 | 1 | −3 | 1 | 3 | 1 | 1 | −1 | 1 | 1 | −3 | −3 |
| 11 | 1 | 1 | −3 | 1 | 3 | 1 | −3 | 3 | −3 | −3 | 1 | 1 |
| 12 | 1 | 3 | 1 | 1 | 1 | −3 | 1 | 3 | 1 | −3 | −3 | 1 |
| 13 | 1 | 3 | 1 | 1 | 1 | −3 | −3 | −1 | −3 | 1 | 1 | −3 |
| 14 | 1 | 1 | −3 | −3 | −1 | −3 | 1 | −1 | 1 | −3 | 1 | 1 |
| 15 | 1 | 1 | −3 | −3 | −1 | −3 | −3 | 3 | −3 | 1 | −3 | −3 |
| 16 | 1 | 3 | 1 | −3 | −3 | 1 | 1 | −3 | −3 | −3 | 3 | −3 |
| 17 | 1 | 3 | 1 | −3 | −3 | 1 | −3 | 1 | 1 | 1 | −1 | 1 |
| 18 | 1 | 3 | 1 | 1 | 1 | −3 | 1 | −3 | −3 | 1 | −1 | 1 |
| 19 | 1 | 3 | 1 | 1 | 1 | −3 | −3 | 1 | 1 | −3 | 3 | −3 |
| 20 | 1 | 1 | −3 | 3 | −3 | 1 | 1 | −3 | −3 | −1 | −3 | −3 |
| 21 | 1 | 1 | −3 | 3 | −3 | 1 | −3 | 1 | 1 | 3 | 1 | 1 |
| 22 | 1 | 1 | −3 | 1 | 3 | 1 | 3 | 3 | −1 | −1 | 1 | −1 |
| 23 | 1 | 1 | −3 | 1 | 3 | 1 | −1 | −1 | 3 | 3 | −3 | 3 |
| 24 | 1 | −3 | 1 | −1 | −3 | −3 | 3 | −1 | 1 | 3 | 3 | 3 |
| 25 | 1 | −3 | 1 | −1 | −3 | −3 | −1 | 3 | −3 | −1 | −1 | −1 |
| 26 | 1 | −1 | 1 | 1 | −3 | −3 | 3 | 1 | 3 | −1 | 3 | 3 |
| 27 | 1 | −1 | 1 | 1 | −3 | −3 | −1 | −3 | −1 | 3 | −1 | −1 |
| 28 | 1 | 1 | 1 | −1 | −3 | 1 | 3 | −1 | 3 | −3 | −1 | −1 |
| 29 | 1 | 1 | 1 | −1 | −3 | 1 | −1 | 3 | −1 | 1 | 3 | 3 |

wherein u indicates a sequence index and φ(n) indicates a sequence corresponding to the sequence index u, n=0, . . . , 11, and wherein the scrambling sequence is [1, 1, 1, 1, 1, 1, −1, −1, −1, −1, −1].

In some embodiments of the present disclosure, at least one of the first spreading sequence and the second spreading sequence may be determined based on a first basic spreading sequence and a second basic spreading sequence.

In some embodiments of the present disclosure, the first basic spreading sequence and the second basic spreading sequence may be a first predetermined spreading sequence and a second predetermined spreading sequence for a system bandwidth of 20 MHz.

In some embodiments of the present disclosure, a first spreading sequence for a system bandwidth of 40 MHz may be formed by cascading the first basic spreading sequence and the second basic spreading sequence; and wherein a second spreading sequence for the system bandwidth of 40 MHz may be formed by cascading the first basic spreading sequence and a negative sequence of the second basic spreading sequence.

In some embodiments of the present disclosure, a first spreading sequence for a system bandwidth of 80 MHz may be formed by cascading a concatenation of the first basic spreading sequence and the second basic spreading sequence and a concatenation of the first basic spreading sequence and a negative sequence of the second basic spreading sequence, and wherein a second spreading sequence for the system bandwidth of 80 MHz may be formed by cascading a concatenation of the first basic spreading sequence and the second basic spreading sequence and a concatenation a negative sequence of the first basic spreading sequence and the second basic spreading sequence.

In some embodiments of the present disclosure, a first spreading sequence for a system bandwidth of 80 MHz may be formed by cascading the first spreading sequence for the system bandwidth of 40 MHz and the second spreading sequence for the system bandwidth of 40 MHz; and wherein a second spreading sequence for the system bandwidth of 80 MHz may be formed by cascading the first spreading sequence for the system bandwidth of 40 MHz and a negative sequence of the second spreading sequence for the system bandwidth of 40 MHz.

In another aspect of the present disclosure, there is further provided another apparatus for resource mapping of uplink data channel. FIG. 17 schematically illustrates a block diagram of an apparatus 1700 for uplink resource mapping in a wireless communication system according to some embodiments of the present disclosure. The apparatus 1700 can be implemented at a terminal device or any other terminal device.

As illustrated in FIG. 1700, the apparatus 1700 may comprise a resource mapping module 1710. In some embodiments of the present disclosure, the resource mapping module 1710 may be configured to map a one-RB PUCCH onto a plurality of clusters within an interlace by spreading the one-RB PUCCH with a third spreading sequence. In some embodiments of the present disclosure, the resource mapping module 1710 may be alternatively configured to map a one-RB Physical Uplink Control Channel (PUCCH) onto a plurality of clusters within an interlace by performing a rate matching on the one-RB PUCCH.

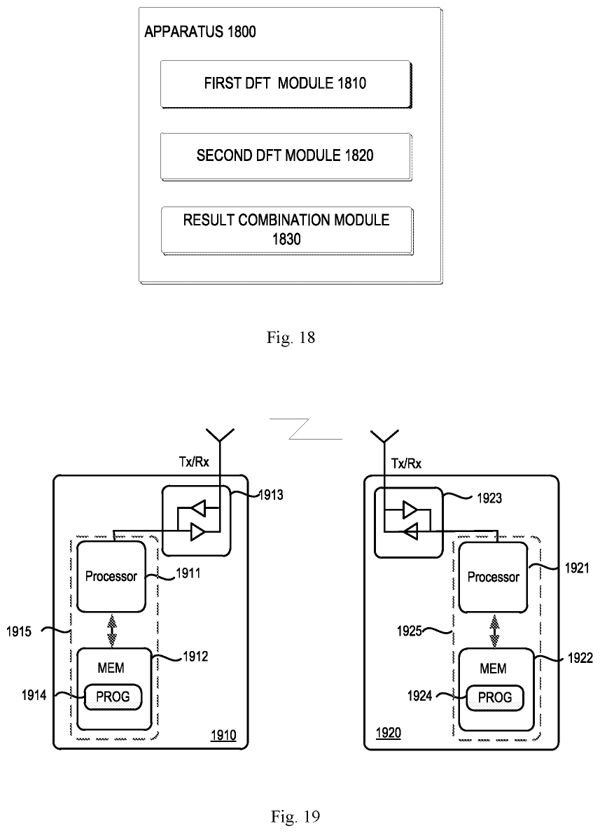

In a further aspect of the present disclosure, there is further provided an apparatus for implementing DFT operation on the data signal. FIG. 18 schematically illustrates a block diagram of an apparatus 1800 for implementing a DFT operation on the data signal in a wireless communication system according to some embodiments of the present disclosure. The apparatus 1800 can be implemented at a terminal device or any other terminal device.

As illustrated in FIG. 18, the apparatus 1800 may comprise a first DFT module 1810, a second DFT module 1820, and a result combination module 1830. The first DFT module 1810 is configured to perform a first Discrete Fourier Transformation (DFT) for a first number of clusters within an interlace on the Physical Uplink Shared Channel (PSUCH) to obtain a first DFT result. The second DFT module 1820 is configured to perform a second DFT for a second number of clusters within the interlace to obtain a second DFT result. The result combination module 1830 is configured to combine the first DFT result and the second DFT result to obtain a final DFT result for the plurality of clusters within the interlace.

Hereinabove, apparatuses 1600 to 1800 are described with reference to FIGS. 16 to 18 in brief. It can be noticed that the apparatuses 1600 to 1800 may be configured to implement functionalities as described with reference to FIGS. 4 to 15. Therefore, for details about the operations of modules in these apparatuses, one may refer to those descriptions made with respect to the respective steps of the methods with reference to FIGS. 4 to 15.

It is further noticed that components of the apparatuses 1600 to 1800 may be embodied in hardware, software, firmware, and/or any combination thereof. For example, the components of apparatuses 1600 to 1800 may be respectively implemented by a circuit, a processor or any other appropriate selection device.

Those skilled in the art will appreciate that the aforesaid examples are only for illustration not limitation and the present disclosure is not limited thereto; one can readily conceive many variations, additions, deletions and modifications from the teaching provided herein and all these variations, additions, deletions and modifications fall the protection scope of the present disclosure.

In addition, in some embodiment of the present disclosure, apparatuses 1600 to 1800 may include at least one processor. The at least one processor suitable for use with embodiments of the present disclosure may include, by way of example, both general and special purpose processors already known or developed in the future. Apparatuses 1600 to 1800 may further include at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause apparatuses 1600 to 1800 to at least perform operations according to the method as discussed with reference to FIGS. 4 to 15 respectively.

FIG. 19 schematically illustrates a simplified block diagram of an apparatus 1910 that may be embodied as or comprised in a terminal device like UE, and an apparatus 1920 that may be embodied as or comprised in a network device like gNB as described herein.

The apparatus 1910 comprises at least one processor 1911, such as a data processor (DP) and at least one memory (MEM) 1912 coupled to the processor 1911. The apparatus 1910 may further include a transmitter TX and receiver RX 1913 coupled to the processor 1911, which may be operable to communicatively connect to the apparatus 1920. The MEM 1912 stores a program (PROG) 1914. The PROG 1914 may include instructions that, when executed on the associated processor 1911, enable the apparatus 1910 to operate in accordance with embodiments of the present disclosure, for example methods 400, 1400. A combination of the at least one processor 1911 and the at least one MEM 1912 may form processing means 1915 adapted to implement various embodiments of the present disclosure.

The apparatus 1920 comprises at least one processor 1921, such as a DP, and at least one MEM 1922 coupled to the processor 1921. The apparatus 1920 may further include a suitable TX/RX 1923 coupled to the processor 1921, which may be operable for wireless communication with the apparatus 1910. The MEM 1922 stores a PROG 1924. The PROG 1924 may include instructions that, when executed on the associated processor 1921, enable the apparatus 1920 to operate actions at the network device in accordance with the embodiments of the present disclosure. A combination of the at least one processor 1921 and the at least one MEM 1922 may form processing means 1925 adapted to implement various embodiments of the present disclosure.

Various embodiments of the present disclosure may be implemented by computer program executable by one or more of the processors 1911, 1921, software, firmware, hardware or in a combination thereof.

The MEMs 1912 and 1922 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1911 and 1921 may be of any type suitable to the local technical environment, and may include one or more of general purpose computers, special purpose computers, microprocessors, digital signal processors DSPs and processors based on multicore processor architecture, as non-limiting examples.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method for uplink resource mapping, comprising:
at a terminal device,
scrambling a reference signal sequence generated based on a predetermined sequence group by a scrambling sequence to obtain another reference signal sequence complementary with the reference signal sequence; and
mapping the reference signal sequence and the another reference signal sequence onto a plurality of clusters within an interlace, by spreading the reference signal sequence with a first spreading sequence and spreading the another reference signal sequence with a second spreading sequence complementary with the first spreading sequence,
wherein the reference signal sequence and the another reference signal sequence are respectively mapped onto a first part and a second part of the plurality of clusters within the interlace.

2. The method of claim 1, wherein the first spreading sequence and the second spreading sequence are two predetermined spreading sequences.

3. The method of claim 1, wherein the first spreading sequence and the second spreading sequence are determined from a spreading sequence table based on a sequence index of the reference signal sequence.

4. The method of claim 3, wherein the spreading sequence table is:

| | a5 | | | | | b5 | | | | |
|---|---|---|---|---|---|---|---|---|---|---|
| | 0 | 1 | 2 | 3 | 4 | 0 | 1 | 2 | 3 | 4 |
| mod(u, 2) = = 0 | 1 | −i | −1 | −1 | −i | i | −i | i | −1 | −1 |
| mod(u, 2) = = 1 | 1 | i | −1 | −1 | i | −i | i | −i | −1 | −1 |

wherein u indicates a sequence index, a5 indicates the first spreading sequence and b5 indicates the second spreading sequence.

5. The method of claim 1, wherein the predetermined sequence group is based on the following sequence table:

| | φ(n), n = 0, . . . 11 | | | | | | | | | | | |
|---|---|---|---|---|---|---|---|---|---|---|---|---|
| u | 0 | 1 | 2 | 3 | 4 | 5 | 6 | 7 | 8 | 9 | 10 | 11 |
| 0 | 3 | −3 | 3 | 1 | −1 | 1 | 1 | −1 | −1 | 1 | 3 | 1 |
| 1 | −1 | 1 | 1 | −3 | −1 | −3 | −1 | 1 | −1 | −1 | 3 | 1 |
| 2 | −1 | −3 | 1 | 1 | −1 | 1 | 3 | 1 | 3 | −1 | −1 | 1 |
| 3 | −1 | −3 | −1 | 3 | 3 | −3 | −1 | −3 | 1 | 1 | −1 | 1 |
| 4 | 1 | −3 | −3 | 1 | −1 | 1 | −3 | 3 | 1 | 1 | 1 | 1 |
| 5 | 1 | 1 | 1 | 1 | −1 | −3 | 1 | 3 | 1 | −3 | −3 | 1 |
| 6 | −1 | 1 | −1 | −1 | 3 | 1 | 3 | −3 | −3 | 1 | 3 | 1 |
| 7 | 3 | 1 | 3 | −3 | 1 | −1 | 3 | −3 | 3 | 1 | −1 | 1 |
| 8 | 3 | −3 | 3 | 1 | −1 | 1 | −3 | 3 | −1 | 1 | 3 | 1 |
| 9 | 3 | 1 | 3 | −3 | −3 | 3 | 3 | −3 | 3 | 1 | −1 | 1 |
| 10 | −3 | −3 | 1 | 1 | −1 | 1 | 1 | −1 | −3 | 1 | −3 | 1 |
| 11 | 1 | 1 | 3 | 3 | 1 | 1 | 1 | −3 | 1 | −3 | −3 | 1 |
| 12 | 1 | 1 | −3 | −3 | 1 | −1 | −1 | 1 | −3 | 1 | −3 | 1 |
| 13 | 1 | −3 | 1 | −3 | 1 | 3 | 3 | 1 | −3 | −3 | 1 | 1 |
| 14 | −3 | −3 | 1 | 1 | 1 | 1 | −3 | 1 | 3 | −1 | −3 | 1 |
| 15 | −3 | −3 | −3 | −3 | 1 | 1 | −3 | 1 | −1 | 3 | −3 | 1 |
| 16 | −3 | 1 | −3 | 1 | −1 | −3 | −3 | −1 | −3 | −3 | 1 | 1 |
| 17 | 1 | −3 | −3 | 1 | −3 | 1 | 1 | 1 | 3 | 3 | 1 | 1 |
| 18 | 1 | −3 | 1 | −3 | −3 | 1 | 1 | 1 | −1 | −1 | 1 | 1 |
| 19 | 1 | 1 | −1 | −1 | 1 | 1 | 1 | −3 | −3 | 1 | −3 | 1 |
| 20 | −3 | 1 | −1 | 3 | −3 | 1 | −3 | −3 | 1 | 1 | 1 | 1 |
| 21 | −3 | 1 | 3 | −1 | −3 | 1 | −3 | −3 | −3 | −3 | 1 | 1 |
| 22 | −3 | −3 | −3 | −3 | −3 | −1 | 3 | 1 | 1 | −3 | −3 | 1 |
| 23 | −1 | −3 | −1 | −1 | 3 | −3 | −1 | −3 | −3 | 1 | −1 | 1 |
| 24 | 3 | 1 | 3 | −3 | −3 | 3 | −1 | 1 | 3 | 1 | −1 | 1 |
| 25 | 3 | −3 | 3 | 1 | 3 | −3 | 1 | −1 | −1 | 1 | 3 | 1 |
| 26 | 3 | −3 | 3 | 1 | 3 | −3 | −3 | 3 | −1 | 1 | 3 | 1 |
| 27 | 3 | 1 | 3 | −3 | 1 | −1 | −1 | 1 | 3 | 1 | −1 | 1 |
| 28 | −1 | 1 | −1 | 3 | 3 | 1 | 3 | −3 | 1 | 1 | 3 | 1 |
| 29 | −3 | 1 | 1 | −3 | −3 | 3 | −1 | 1 | 1 | 1 | 1 | 1 |

wherein u indicates a sequence index and φ(n) indicates a sequence corresponding to the sequence index u, n=0, . . . , 11, and wherein the scrambling sequence is [1, −1, 1, −1, 1, −1, 1, −1, 1, −1, 1, −1].

6. The method of claim 1, wherein the predetermined sequence group is based on the following sequence table:

| | φ(n), n = 0, . . . 11 | | | | | | | | | | | |
|---|---|---|---|---|---|---|---|---|---|---|---|---|
| u | 0 | 1 | 2 | 3 | 4 | 5 | 6 | 7 | 8 | 9 | 10 | 11 |
| 0 | 1 | −3 | 1 | 3 | −3 | −3 | 1 | −3 | 3 | 1 | 1 | 1 |
| 1 | 1 | −3 | 1 | 3 | −3 | −3 | −3 | 1 | −1 | −3 | −3 | −3 |
| 2 | 1 | −3 | −1 | −3 | 1 | 1 | 1 | −3 | −3 | −1 | −3 | −3 |
| 3 | 1 | −3 | −1 | −3 | 1 | 1 | −3 | 1 | 1 | 3 | 1 | 1 |
| 4 | 1 | −3 | 3 | −3 | 1 | 1 | 3 | −1 | −1 | −3 | −1 | −1 |
| 5 | 1 | −3 | 3 | −3 | 1 | 1 | −1 | 3 | 3 | 1 | 3 | 3 |
| 6 | 1 | 1 | −1 | 1 | 1 | −3 | 1 | −3 | −1 | −3 | 1 | 1 |
| 7 | 1 | 1 | −1 | 1 | 1 | −3 | −3 | 1 | 3 | 1 | −3 | −3 |
| 8 | 1 | −3 | −3 | 1 | −1 | 1 | 1 | −3 | −3 | −3 | 3 | −3 |
| 9 | 1 | −3 | −3 | 1 | −1 | 1 | −3 | 1 | 1 | 1 | −1 | 1 |
| 10 | 1 | 1 | −3 | 1 | 3 | 1 | 1 | −1 | 1 | 1 | −3 | −3 |
| 11 | 1 | 1 | −3 | 1 | 3 | 1 | −3 | 3 | −3 | −3 | 1 | 1 |
| 12 | 1 | 3 | 1 | 1 | 1 | −3 | 1 | 3 | 1 | −3 | −3 | 1 |
| 13 | 1 | 3 | 1 | 1 | 1 | −3 | −3 | −1 | −3 | 1 | 1 | −3 |
| 14 | 1 | 1 | −3 | −3 | −1 | −3 | 1 | −1 | 1 | −3 | 1 | 1 |
| 15 | 1 | 1 | −3 | −3 | −1 | −3 | −3 | 3 | −3 | 1 | −3 | −3 |
| 16 | 1 | 3 | 1 | −3 | −3 | 1 | 1 | −3 | −3 | −3 | 3 | −3 |
| 17 | 1 | 3 | 1 | −3 | −3 | 1 | −3 | 1 | 1 | 1 | −1 | 1 |
| 18 | 1 | 3 | 1 | 1 | 1 | −3 | 1 | −3 | −3 | 1 | −1 | 1 |
| 19 | 1 | 3 | 1 | 1 | 1 | −3 | −3 | 1 | 1 | −3 | 3 | −3 |
| 20 | 1 | 1 | −3 | 3 | −3 | 1 | 1 | −3 | −3 | −1 | −3 | −3 |
| 21 | 1 | 1 | −3 | 3 | −3 | 1 | −3 | 1 | 1 | 3 | 1 | 1 |
| 22 | 1 | 1 | −3 | 1 | 3 | 1 | 3 | 3 | −1 | −1 | 1 | −1 |
| 23 | 1 | 1 | −3 | 1 | 3 | 1 | −1 | −1 | 3 | 3 | −3 | 3 |
| 24 | 1 | −3 | 1 | −1 | −3 | −3 | 3 | −1 | 1 | 3 | 3 | 3 |
| 25 | 1 | −3 | 1 | −1 | −3 | −3 | −1 | 3 | −3 | −1 | −1 | −1 |
| 26 | 1 | −1 | 1 | 1 | −3 | −3 | 3 | 1 | 3 | −1 | 3 | 3 |
| 27 | 1 | −1 | 1 | 1 | −3 | −3 | −1 | −3 | −1 | 3 | −1 | −1 |
| 28 | 1 | 1 | 1 | −1 | −3 | 1 | 3 | −1 | 3 | −3 | −1 | −1 |
| 29 | 1 | 1 | 1 | −1 | −3 | 1 | −1 | 3 | −1 | 1 | 3 | 3 |

wherein u indicates a sequence index and φ(n) indicates a sequence corresponding to the sequence index u, n=0, . . . , 11, and wherein the scrambling sequence is [1, 1, 1, 1, 1, 1, −1, −1, −1, −1, −1, −1].

7. The method of claim 1, wherein at least one of the first spreading sequence and the second spreading sequence is determined based on a first basic spreading sequence and a second basic spreading sequence.

8. The method of claim 7, wherein the first basic spreading sequence and the second basic spreading sequence are a first spreading sequence and a second spreading sequence for a system bandwidth of 20 MHz.

9. The method of claim 7, wherein a first spreading sequence for a system bandwidth of 40 MHz is formed by cascading the first basic spreading sequence and the second basic spreading sequence; and
wherein a second spreading sequence for the system bandwidth of 40 MHz is formed by cascading the first basic spreading sequence and a negative sequence of the second basic spreading sequence.

10. The method of claim 7, wherein a first spreading sequence for a system bandwidth of 80 MHz is formed by cascading a concatenation of the first basic spreading sequence and the second basic spreading sequence and a concatenation of the first basic spreading sequence and a negative sequence of the second basic spreading sequence, and
wherein a second spreading sequence for the system bandwidth of 80 MHz is formed by cascading a concatenation of the first basic spreading sequence and the second basic spreading sequence and a concatenation a negative sequence of the first basic spreading sequence and the second basic spreading sequence.

11. The method of claim 9, wherein a first spreading sequence for a system bandwidth of 80 MHz is formed by cascading the first spreading sequence for the system bandwidth of 40 MHz and the second spreading sequence for the system bandwidth of 40 MHz; and
wherein a second spreading sequence for the system bandwidth of 80 MHz is formed by cascading the first spreading sequence for the system bandwidth of 40 MHz and a negative sequence of the second spreading sequence for the system bandwidth of 40 MHz.

12. The method of claim 1, further comprising:
mapping a one-RB Physical Uplink Control Channel (PUCCH) onto a plurality of clusters within an interlace by spreading the one-RB PUCCH with a third spreading sequence.

13. The method of claim 1, further comprising:
mapping a one-RB Physical Uplink Control Channel (PUCCH) onto a plurality of clusters within an interlace by performing a rate matching on the one-RB PUCCH.

14. The method of claim 1, further comprising;
performing a first Discrete Fourier Transformation (DFT) for a first number of clusters within an interlace on the Physical Uplink Shared Channel (PSUCH) to obtain a first DFT result;
performing a second DFT for a second number of clusters within the interlace to obtain a second DFT result;
combining the first DFT result and the second DFT result to obtain a final DFT result for the plurality of clusters within the interlace.

15. A terminal device, comprising:
at least one processor; and
at least one memory coupled with the at least one processor;
the at least one memory having computer program codes therein are configured to, when executed on the at least one processor, cause the terminal device at least to perform the method of claim 1.

16. A computer readable medium having a computer program stored thereon which, when executed by at least one processor of a device, causes the device to perform the method of claim 1.
